(19) United States
(12) Patent Application Publication
(10) Pub. No.: US 2002/0158160 A1
(43) Pub. Date: Oct. 31, 2002

(54) Fishing reel

(75) Inventor: Yoshihito Shimizu, Tokyo (JP)

Correspondence Address: SUGHRUE MION, PLLC, 2100 PENNSYLVANIA AVENUE, N.W., WASHINGTON, DC, 20037, US

(73) Assignee: DAIWA SEIKO, INC.

(21) Appl. No.: 10/132,223

(22) Filed: Apr. 26, 2002

(30) Foreign Application Priority Data
Apr. 26, 2001 (JP) P2001-129147

(51) Int. Cl. A01K 89/00; A01K 89/015

(52) U.S. Cl. 242/223

(57) ABSTRACT

A fishing reel has an indicator which is attached to a reel main unit capable of rotatably supporting a spool and which displays various fishing information items; an illumination member which is provided in the indicator and illuminates the inside of the indicator; detector for detecting an operating status of a member attached to the reel main unit; storage unit for storing at least requirements for extinguishing the illumination member set on the basis of the operating status of the member attached to the reel main unit; and controller for inputting a result of detection performed by the detector. The controller automatically extinguishes the illumination member on the basis of the result of detection operation performed by the detector and the extinction requirements.

### BACKGROUND OF THE INVENTION

The present invention relates to a fishing reel comprising a reel main unit and an indicator provided thereon for displaying various kinds of fishing information items.

In order to improve a catch of fish, the majority of recent fishing reels are equipped with a line length measurement device. In the line length measurement device, a number-of-rotations detector detects the number of rotations of a spool. On the basis of the thus-detected number of rotations, the length of an unreeled fishing line is measured, and the thus-measured length is displayed on an indicator provided on a control panel.

Nowadays, fishing reels are equipped with various electronic controllers—which enable measurement and input of various fishing information items or setting information items and display the information items on an indicator—including a target-depth-and-location stopper and a gunwale stopper, thus growing and expanding in functionality. Here, the target-depth-and-location stopper stops unreeling terminal tackle at a depth and position where target fish are expected (hereinafter simply called a “target depth—and position”), by means of actuating a clutch mechanism through use of an actuator, such as a motor or a solenoid, on the basis of the value measured by the line length measurement device. Further, when the terminal tackle is reeled in to reach a gunwale stop position, the gunwale stopper automatically halts a spool motor, in consideration of protection of the extremity of a fishing rod from damage stemming from reeling of a fishing line, to thereby stop reeling in of a fishing line.

A button battery attached to the reel main unit has hitherto been used as a power source for activating the indicator. The fishing reel is constructed so that an angler can sufficiently view indicated values by means of illuminating the inside of the indicator when a line length is being measured and the power is in an ON position, on the assumption that the fishing reel is to be used both day and night.

However, it has been pointed out that illumination of the indicator under bright daytime conditions is useless and results in unnecessary consumption of the button battery.

For this reason, Japanese Utility Model Application Laid-Open No. 68449/1994 proposes a fishing reel. In this reel, a light-receiving element is placed in the vicinity of an indicator. In accordance with the result of detection of external light or darkness by the light-receiving element, an illuminating member provided in the indicator is activated or deactivated through control, thereby preventing unnecessary consumption of power when the fishing reel is used under daytime conditions.

However, the fishing reel described in Japanese Utility Model Application Laid-Open No. 68449/1994 suffers from the following problem. Even when there is little chance or necessity of viewing indicated values appearing on the indicator, such as in the case of nighttime fishing with a fishing rod being seated in a holder, an illumination member is left illuminated when the outside has become dark, thereby wastefully consuming power. Thus, the life of the button battery is shortened.

### SUMMARY OF THE INVENTION

The present invention has been conceived under the circumstances and aims at providing a fishing reel which ensures visibility of indicated values by means of illumination of the inside of an indicator and suppresses wasteful power consumption.

(1) A fishing reel comprising:

a reel main unit;

a spool rotatably supported by the reel main unit;

an indicator attached to the reel main unit and displaying various fishing information items;

an illumination member, for illuminating an inside of the indicator, provided in the indicator;

a detector for detecting an operating status of a member attached to the reel main unit;

a storage unit storing at least extinction requirements for extinguishing the illumination member set on the basis of the operating status of the member; and

a controller for inputting the detection result obtained by the detector, wherein the controller automatically extinguishes the illumination member on the basis of the detection result and the extinction requirement.

(2) The fishing reel according to (1), wherein the extinction requirement is set on the basis of the operating status of a rotary member rotated by unreeling a fishline wound around the spool or rotating a handle attached to the reel main unit.

(3) The fishing reel according to (1), wherein illumination and extinction requirements for illuminating and extinguishing the illumination member are stored in the storage unit, and the illumination and extinction requirements are set on the basis of the operating status of a rotary member rotated by unreeling a fishline wound around the spool or rotating a handle attached to the reel main unit.

(4) The fishing reel according to (1), wherein a sensor for detecting darkness or light outside of the reel main unit is provided in the vicinity of the indicator,

condition of darkness or light outside of the reel main unit is added to requirements for illuminating and extinguishing the illumination member, and

the controller automatically controls illumination and extinction of the illumination member on the basis of a detection result obtained by the detector and the sensor and the illumination and extinction requirements.

(5) The fishing reel according to (1) , wherein the controller extinguishes the illumination member when the spool remains stationary over a predetermined period.

(6) The fishing reel according to (1), wherein the member is the spool.

(7) The fishing reel according to (2), wherein the rotary member is the spool.

According to the inventions, the detector detects an operating status of a member and that of a rotary member, which are attached to the reel main unit, at the time of an actual fishing operation. The controller controls extinction of the illumination member on the basis of a result of detection performed by the detector and the extinction requirement stored in the storage unit.

According to the invention, the detector detects the operating status of the rotary member, and the controller automatically controls illumination and extinction of the illumination member on the basis of the result of detection operation and on the basis of illumination and extinction requirements stored in the storage unit.

According to the invention, the sensor detects darkness or light outside the reel main unit, and the detector detects the operating status of the rotary member.

The controller automatically controls extinction and illumination of the illumination member on the basis of the result of detection operation and the illumination and extinction requirements stored in the storage unit.

### BRIEF DESCRIPTION OF DRAWINGS

FIG. 1 is a plan view of a fishing reel according to an embodiment defined in claims 1, 3, and 4;

FIG. 2 is an enlarged cross-sectional view of the principal section of the fishing reel shown in FIG. 1; and

FIG. 3 is a control block diagram of the fishing reel shown in FIG. 1.

### DETAILED DESCRIPTION OF PREFERRED EMBODIMENTS

An embodiment of the invention will be described hereinbelow in detail by reference to the accompanying drawings.

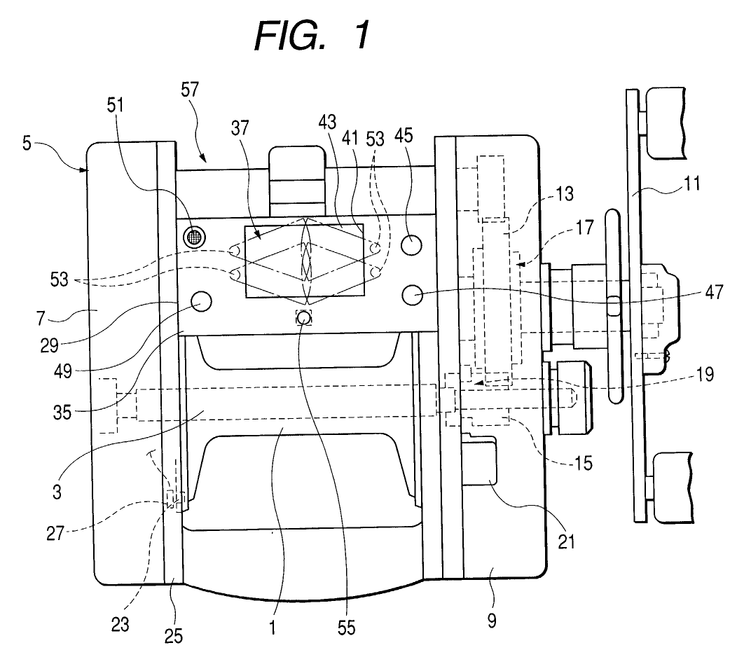

FIG. 1 shows a fishing reel according to an embodiment of the present invention. As illustrated, reference numeral 1 designates a spool rotatably supported between side plates 7, 9 of a reel main unit 5 by way of a spool shaft 3. Reference numeral 11 designates a handle provided at the side of the side plate 9. Interposed between the handle 11 and the spool 1 are a power transmission mechanism 17 including a drive gear 13, and a clutch mechanism 19 including a pinion gear 15.

A clutch lever 21 of the clutch mechanism 19 is attached to a position behind the side plate 9. By means of actuation of the clutch lever 21, the clutch mechanism 19 is switched between an ON position and an OFF position. Transmission of torque of the handle 11 to the spool 1 is established or canceled by means of the power transmission mechanism 17.

A magnet 23 is attached to one side surface of the spool 1. A pair of lead switches 27 are attached to a frame 25 of the reel main unit 5 so as to face a rotary path of the magnet 23. These elements act as a spinning detector for detecting the rotating direction of and the number of spins of the spool 1. The lead switches 27 are connected to controller provided in a control box 29 located in an upper part of the reel main unit 5 and between the side plate 7 and the side plate 9.

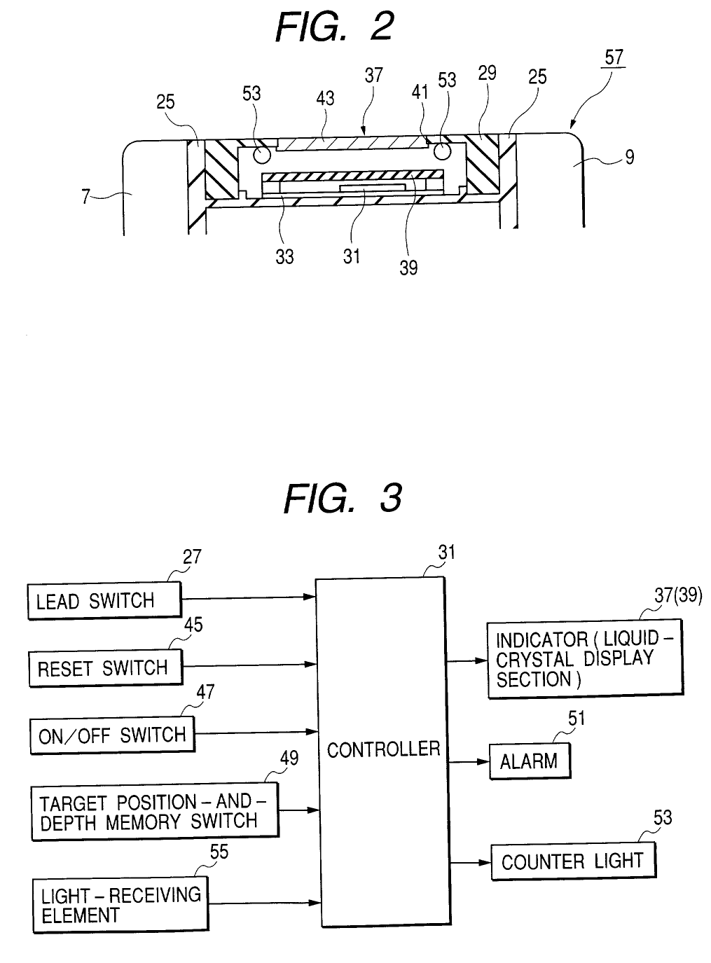

A controller 31 is constituted by a microcomputer, and, as shown in FIG. 2, is mounted on a circuit board 33 along with other, unillustrated electronic components. ROM of the controller 31 is programmed with a line length measurement method (or a line length measurement device) identical with that stored in a fishing reel described in Japanese Patent Application Laid-Open No. 103567/1993. A CPU of the controller 31 receives from the lead switches 27 a determination signal as to forward/reverse spinning of the spool 1, thereby determining whether a fishing line is unreeled or reeled. A spinning pulse signal pertaining to the spool 1 output from the lead switches 27 is counted by means of an up/down counter. On the basis of the resultant count value, the CPU calculates a line length by means of a computation equation stored in the ROM.

As shown in FIG. 1, a control panel 35 mounted on the control box 29 is equipped with an indicator 37. The CPU displays the thus—computed line length measurement value on the indicator 37 through a display drive circuit.

As shown in FIG. 2, the indicator 37 comprises a liquid-crystal display section 39 mounted on the circuit board 33; and a protective panel 43 made of a transparent acrylic plate and fitted to an opening section 41 of the control panel 35 so as to cover the liquid-crystal display section 39. Displayed on the liquid-crystal display section 39 are various types of fishing information items and setting information items measured by and output from the CPU, including the line length measurement value measured by the line length measurement unit.

A line length display or the like appearing on the indicator 37 is reset by means of actuation of a reset switch 45 provided on the control panel 35. In addition to having the reset switch 45 provided thereon, the control panel has the controller 31, an ON/OFF switch 47 of the indicator 37, and a target depth-and-position memory switch 49 provided thereon. These switches and devices are mounted on the circuit board 33 and connected to the controller 31 in the manner shown in FIG. 3.

If an angler actuates the target position-and-depth switch 49 while viewing an indication appearing on the indicator 37 in order to set a target depth and position at a depth of 50 m from a water surface, that is, terminal tackle is to be at a depth of 50 m from a water surface, the CPU of the controller 31 stores the depth 50 m as a target depth and position in the RAM. If the terminal tackle is unreeled to the target position and depth in an actual fishing operation, the CPU is constructed so as to activate an alarm 51 mounted on the circuit board 33 on the basis of a line length measurement value.

Accordingly, the angler can feed the terminal tackle accurately to a target position and depth by means of switching the clutch lever 15 to an ON position in accordance with operation of the alarm 51.

Although not illustrated, a button battery serving as an operating power source for the controller 31, the indicator 37 and other unillustrated electronic components is disposed in the control box 29. These elements are activated by switching the ON/OFF switch 47 to an ON position.

As shown in FIG. 2, two counter lights (illumination members) 53 are provided on opposite sides of the opening section 41 within the indicator 37, and the liquid-crystal display section 39 is illuminated by the counter lights 53.

A light-receiving element (sensor) 55, such as a photodiode or a phototransistor, is attached to the neighborhood of the indicator 37 provided on the control panel 35. When external light (i.e., the light that has fallen onto a fishing spot) is received by the light-receiving element 55, a detection signal is input to the controller 31.

In the embodiment, requirements for illuminating and extinguishing the counter lights 53 are stored beforehand in the ROM of the controller 31. On the basis of the requirements, the controller 31 automatically controls illumination/extinction of the counter lights 53.

In the embodiment, the following two requirements are stored in the ROM as requirements for illuminating the counter lights 53 (often called “illumination requirements”). Namely,

(1) No detection signal is output from the light-receiving element 55.

(2) The spool 1 is spun forward/in reverse at a rate of three or more rotations per second.

The following two requirements are stored in the ROM as requirements for extinguishing the counter lights 53 (often called “extinction requirements”).

(3) A detection signal is output from the light-receiving element 55.

(4) The spool 1 has remained stationary over a predetermined period of time (e.g., 10 seconds).

(Here, two forward/reverse rotation or less per second of the spool 1 are assumed to represent a stationary state).

On the basis of a forward/reverse spinning determination signal pertaining to the spool 1 received through the lead switch 27 and on the basis of a spinning pulse signal pertaining to the spool 1, the controller 31 detects, through use of an unillustrated timer, an operating status of the spool 1 (i.e., a rotary member) which spins as a result of unreeling of a fishing line or spinning of the handle 11. Simultaneously, when both requirements (1), (2) have been satisfied; that is, when the spool 1 has spun three or more rotations in one second, and when no detection signal is output from the light-receiving element 55 since it is dark outside as in the case of night fishing, the counter lights 53 are illuminated by way of an unillustrated drive circuit.

Even when the counter lights 53 are illuminated in the manner mentioned above, if the spool 1 has remained stationary for ten seconds during the course of unreeling of the terminal tackle to a target position and depth or has stopped rotating continuously for more than ten seconds as in the case of fish being hauled in after the fishing line has been reeled in fully, the controller 31 determines that the extinction requirement (4) has been satisfied, and thereby extinguishes the counter lights 53. If either one of the extinction requirements (3) and (4) is determined to have been satisfied, the controller 31 extinguishes the counter lights 53, thereby preventing unnecessary consumption of the button battery.

Even when the spool 1 has spun three or more rotations per second as a result of unreeling or reeling of a fishing line during bright daytime hours, a detection signal output from the light-receiving element 55 is input to the controller 31. Hence, the counter lights 53 remain unilluminated. The controller 31 remains inactive unless the ON/OFF switch 47 is switched to an ON position. As a result, the counter lights 53 remain unilluminated. Moreover, if the controller 31 and the indicator 37 are stopped at the time of illumination of the counter lights 53 by means of switching the ON/OFF switch 47 to an OFF position, the counter lights 53 are extinguished simultaneously.

Since the fishing reel 57 according to the embodiment is constructed in the manner described above, the controller 31 and the indicator 37 are activated, so long as the ON/OFF switch 47 is set to an ON position in a fishing spot.

If the angler unreels a fishing line from the spool 1, the CPU of the controller 31 measures the length of the fishing line in accordance with a spinning pulse signal pertaining to the spool 1 output from the lead switch 27 and indicates the resultant line length measurement value on the indicator 37 (i.e., the liquid-crystal display section 39). If, while viewing readings on the indicator 37, the angler actuates the target position-and-depth memory switch 49; for example, when the terminal tackle has reached to a depth of 50 m from the water surface, the corresponding depth is set as a target position and depth. Subsequently, if the angler has a hit and actuates the handle 11, the spool 1 is spun, thereby reeling in the fishing line.

Through the foregoing series of fishing actions, the controller 31 checks the operating status of the spool 1 in accordance with the forward/reverse spinning determination signal pertaining to the spool 1 and the spinning pulse signal pertaining to the spool 1, which are output from the lead switch 27, and in association with switching of the ON/OFF switch 47 to an ON position. Concurrently, the controller 31 checks at all times whether or not the operating status of the spool 1 matches either the previously-described illumination requirements (1) , (2) or the extinction requirements (3), (4).

If the spool 1 has spun three or more rotations per sec. in association with unreeling of a fishing line; if it is dark outside as in the case of night fishing; and if the detection signal is not output from the light-receiving element 55, the controller 31 illuminates the counter lights 53 through a drive circuit. Consequently, the counter lights 53 illuminate the liquid-crystal display section 39, whereby the angler can view, without fail, the line length measurement value appearing on the liquid-receiving crystal display section 39.

If the spool 1 has remained stationary for more than 10 seconds for reasons of maintaining the terminal tackle at a target position and depth after the fishing line has been unreeled while the counter lights 53 are illuminated, the controller 31 determines that the extinction requirement (4) has been satisfied, and extinguishes the counter lights 53.

If the spool 1 is spun to unreel the fishing line as a result of a hit and if the spool 1 has spun three or more rotations per second, the controller 31 illuminates the counter lights 53. Therefore, as a result of illumination of the counter lights 53, the angler can visually grasp a hit of fish by means of illumination. Thus, the counter lights 53 provide a kind of hit detection function.

Even when the counter lights 53 are illuminated in the manner mentioned above, if the spool 1 has remained continuously stationary for more than 10 seconds as in the case of fish being hauled in after the fishing line has been reeled in fully, the controller 31 determines that the extinction requirement (4) has been satisfied, and extinguishes the counter lights 53.

As has been mentioned, if fishing is performed during bright daytime hours, even when the spool 1 has spun three or more rotations per second in association with unreeling of the fishing line, the detection signal output from the light-receiving element 55 is input to the controller 31. For this reason, the counter lights 53 remain unilluminated. Moreover, the controller 31 remains inactive unless the ON/OFF switch 47 is set to the ON position, and hence the counter lights 53 still remain unilluminated. If the controller 31 and the indicator 37 are stopped at the time of illumination of the counter lights 53 by means of setting the ON/OFF switch 47 to the OFF position, the counter lights 53 can be extinguished simultaneously.

As mentioned, in the embodiment, the following two requirements are stored beforehand in the ROM of the controller 31 as requirements for illuminating the counter lights 53:

(1) No detection signal is output from the light-receiving element 55.

(2) The spool 1 is spun forward/in reverse at a rate of three or more rotations per second.

Moreover, the following two requirements are stored beforehand in the ROM as requirements for extinguishing the counter lights 53.

(3) A detection signal is output from the light-receiving element 55.

(4) The spool 1 has stopped spinning for a predetermined period of time (e.g., 10 seconds).

The controller 31 automatically controls illumination and extinction of the counter lights 53 in accordance with the foregoing requirements. Hence, in the embodiment, when the angler fishes in night fishing without holding a fishing rod (e.g., when a fishing rod is set stationary on a fishing boat), the counter lights 53 are extinguished. Useless power consumption can be prevented without fail, unlike the case described in Japanese Utility Model Laid-Open No. 68449/1994.

In the embodiment, the counter lights 53 can be turned on/off timely in accordance with a series of actual fishing actions [standby (extinction)→unreeling of a fishing line/spinning of a spool (illumination)→interruption of a fishing action, stopping of spinning of a spool, or slight spinning of the spool (extinction)]. Hence, an angler can perform night fishing without problem. Since the counter lights 53 are illuminated as a result of unreeling of a fishing line, the angler can visually ascertain a hit. Thus, there is yielded an advantage of the ability to effectively utilize the counter lights 53 as a kind of hit detection signal.

In place of the illumination requirements (1), (2), an ON/OFF switch for counter lights may be provided on a control panel. The counter lights may be illuminated by activation of the ON/OFF switch, and the counter lights maybe extinguished through control in accordance with the extinction requirements (3), (4). In the case of an electric fishing reel such as that described in Japanese Patent Publication No. 2977978, in which an output of a spool motor is arbitrarily adjustable by means of a power lever (i.e., motor output adjustment means) mounted on a reel main unit, counter lights may be arranged so as to become illuminated in association with actuation of the power lever. Even in the embodiment, a predetermined object can be attained in the same manner as in the embodiment set forth.

As has been described, according to the fishing reel of the present invention, illumination members are extinguished when, for example, an angler does not hold a fishing reel in night fishing, so that unnecessary power consumption can be prevented without fail.

According to the fishing reel of the present invention, the illumination members can be illuminated/extinguished in accordance with a round of actual fishing actions. Hence, there is yielded an advantage that an angler can perform night fishing without involvement of any problem.

Since the illumination members are illuminated in association with unreeling of a fishing line, the angler can visually ascertain a hit. Hence, the illumination members can be effectively utilized as a kind of hit detection signal.

Further, According to the fishing reel of the present invention, illumination of the illumination members can be automatically controlled at the time of only night fishing by use of the fishing reel in combination with a sensor for detecting darkness or light outside the reel main unit. Hence, there is yielded an advantage of the ability to prevent, without fail, unnecessary power consumption.

What is claimed is:

1. A fishing reel comprising:
a reel main unit;
a spool rotatably supported by the reel main unit;
an indicator attached to the reel main unit and displaying various fishing information items;
an illumination member, for illuminating an inside of the indicator, provided in the indicator;
a detector for detecting an operating status of a member attached to the reel main unit;
a storage unit storing at least extinction requirements for extinguishing the illumination member set on the basis of the operating status of the member; and
a controller for inputting the detection result obtained by the detector, wherein the controller automatically extinguishes the illumination member on the basis of the detection result and the extinction requirement.

2. The fishing reel according to claim 1, wherein the extinction requirement is set on the basis of the operating status of a rotary member rotated by unreeling a fishline wound around the spool or rotating a handle attached to the reel main unit.

3. The fishing reel according to claim 1, wherein illumination and extinction requirements for illuminating and extinguishing the illumination member are stored in the storage unit, and the illumination and extinction requirements are set on the basis of the operating status of a rotary member rotated by unreeling a fishline wound around the spool or rotating a handle attached to the reel main unit.

4. The fishing reel according to claim 1, wherein a sensor for detecting darkness or light outside of the reel main unit is provided in the vicinity of the indicator,
condition of darkness or light outside of the reel main unit is added to requirements for illuminating and extinguishing the illumination member, and
the controller automatically controls illumination and extinction of the illumination member on the basis of a detection result obtained by the detector and the sensor and the illumination and extinction requirements.

5. The fishing reel according to claim 1, wherein the controller extinguishes the illumination member when the spool remains stationary over a predetermined period.

6. The fishing reel according to claim 1, wherein the member is the spool.

7. The fishing reel according to claim 2, wherein the rotary member is the spool.
